(19) United States
(12) Patent Application Publication
(10) Pub. No.: US 2012/0089923 A1
(43) Pub. Date: Apr. 12, 2012

(54) DYNAMIC COMPANION DEVICE USER INTERFACE

(75) Inventors: Bradley Robert Pettit, Los Gatos, CA (US); Eilish Lancester, San Francisco, CA (US)

(73) Assignee: MICROSOFT CORPORATION, Redmond, WA (US)

(21) Appl. No.: 12/901,370

(22) Filed: Oct. 8, 2010

(51) Int. Cl. G06F 3/01

(52) U.S. Cl. 715/746

(57) ABSTRACT

A method of dynamically changing a user interface of a companion device configured to remotely control an entertainment system is provided. The method includes establishing two-way communication with the entertainment system, and registering one or more trigger events with the entertainment system. The method further includes, upon occurrence of a trigger event, receiving a notification of the trigger event from the entertainment system, and dynamically changing the user interface of the companion device responsive to the notification.

### BACKGROUND

Input devices may be used to interface with various types of electronic devices, such as those of an entertainment system. In particular, such input devices may allow for a user to interface with the entertainment system wirelessly. Traditionally, input devices (e.g., remote controls) may be configured for one-way communication, so as to transmit commands to the entertainment system. As such, it may be difficult to enhance the user experience associated with the entertainment system by expanding the user experience to incorporate the input device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, a method of dynamically changing a user interface of a companion device configured to remotely control an entertainment system is provided. The method includes establishing two-way communication with the entertainment system, and registering one or more trigger events with the entertainment system. The method further includes, upon occurrence of a trigger event, receiving a notification of the trigger event from the entertainment system, and dynamically changing the user interface of the companion device responsive to the notification.

### BRIEF DESCRIPTION OF THE DRAWINGS

FIG. 1 schematically shows an example use environment in accordance with an embodiment of the present disclosure.

FIG. 2 schematically shows an example use scenario in accordance with an embodiment of the present disclosure.

FIG. 3 shows a flow diagram of an example method of dynamically changing a user interface of the companion device.

FIG. 4 shows an example computing system in accordance with an embodiment of the present disclosure.

### DETAILED DESCRIPTION

An input device may utilize communication protocols and/or networking protocols such as Internet protocols, infrared protocols, radio-frequency protocols, Universal Plug and Play (UPnP), etc. to interface with an entertainment system. However, the user experience is typically fairly restricted in such an environment. Traditionally, input devices support one-way communication to the entertainment system but may not be configured to receive content from the entertainment system via a back channel. As such, the entertainment system is unable to provide content and/or information to the input device. The present disclosure is directed to an input device configured to provide an expanded user experience by displaying companion content (e.g., themed user interface, related programming, images, advertisements, etc.) related to content being provided by an entertainment system.

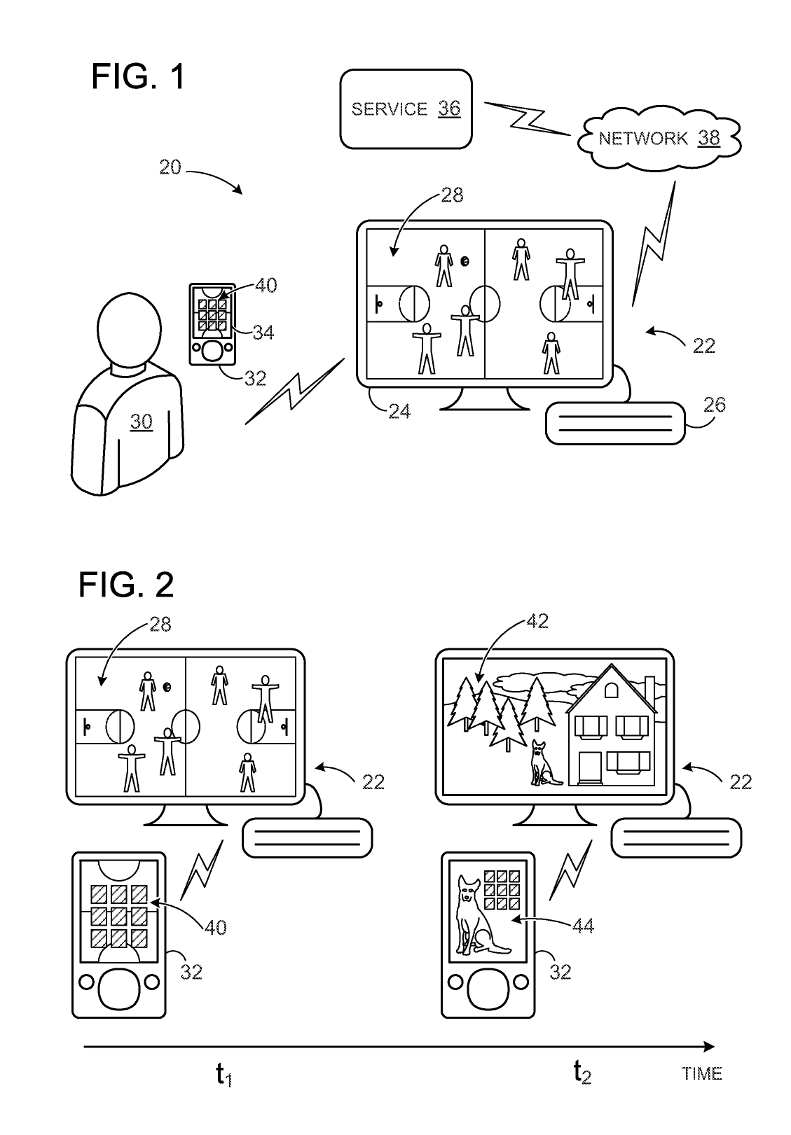

As a nonlimiting example, FIG. 1 illustrates an example use environment 20, including an entertainment system 22 configured to provide content to one or more viewers. Entertainment system 22 may include any suitable computing devices and/or media components. For example, entertainment system 22 may include a display device 24 (e.g., a television) and a content device 26 (e.g., a set-top box) for receiving content signals from a content provider and providing the content to the display device 24 for display. It should be appreciated that entertainment system 22 may include any additional and/or alternative devices without departing from the scope of this disclosure.

The content signals received by entertainment system 22 may be provided by any suitable content source, such as a cable television provider, a satellite television provider, an Internet protocol television (IPTV) provider, a media-disc player, a digital video recorder, data stored on mass storage, etc. In the depicted example, entertainment system 22 is displaying content 28 of a basketball game.

A user 30 may interface with entertainment system 22 via a companion device 32, such as the user's mobile communication device. Thus, companion device 32 may be configured as an input device for entertainment system 22 as well as being configured as a computing and/or communication device. For example, companion device 32 may be configured to communicate via two-way radio telecommunications over a cellular network. Companion device 32 may additionally or alternatively be configured to communicate via other technologies such as via the Internet, Bluetooth, infrared, radio-frequency, etc. Further, companion device 32 may additionally be configured to send and/or receive text communications (e.g., SMS messages, email, etc.). As depicted, companion device 32 includes a display 34 for displaying content. Such content may be received from any suitable source, such as local mass storage at companion device 32, entertainment system 22, a service 36 via a network 38, etc.

Companion device 32 may register itself with entertainment system 22 so as to receive notifications when desired events occur, such as channel changes, advertisements, etc. In some embodiments, the companion device 32 may register itself by sending a registration message to the entertainment system. In some embodiments, the companion device 32 may register itself by sending a registration message to service 36.

A registration message may be virtually any suitable format without departing from the scope of this disclosure. In some embodiments, the registration message may be formatted with an extensible markup language. In some embodiments, an application programming interface may be established for registration communications and/or event notifications.

Event notifications that are sent responsive to registered trigger events may be sent from entertainment system 22 and/or service 36 via network 38. Further, upon receiving an event notification, companion device 32 may dynamically change the user interface 40 displayed on display 34 of companion device 32. In the depicted example, companion device 32 is displaying a basketball-themed user interface which corresponds to the basketball game of content 28 provided by entertainment system 22.

In some embodiments, companion device 32 may be configured to determine the content being displayed at display device 24 by querying (e.g., “polling”) content device 26. The companion device 32 may poll the content device at virtually any fixed or variable interval using any suitable approach.

FIG. 2 illustrates another example use scenario illustrating dynamic changing of the user interface at the companion device. As shown at a first time t₁, entertainment system 22 displays content 28 of a basketball game, and companion device 32 has a corresponding basketball-themed user interface 40. However, at a subsequent time t₂, the content displayed at entertainment system 22 changes, such that entertainment system 22 displays updated content 42 of a movie. A notification of this event is sent to companion device 32, and responsive to the notification, companion device 32 dynamically changes user interface 40 to correspond to content 42, as depicted at user interface 44.

It should be appreciated that the above-described examples of FIGS. 1 and 2 are not intended to be limiting in any way.

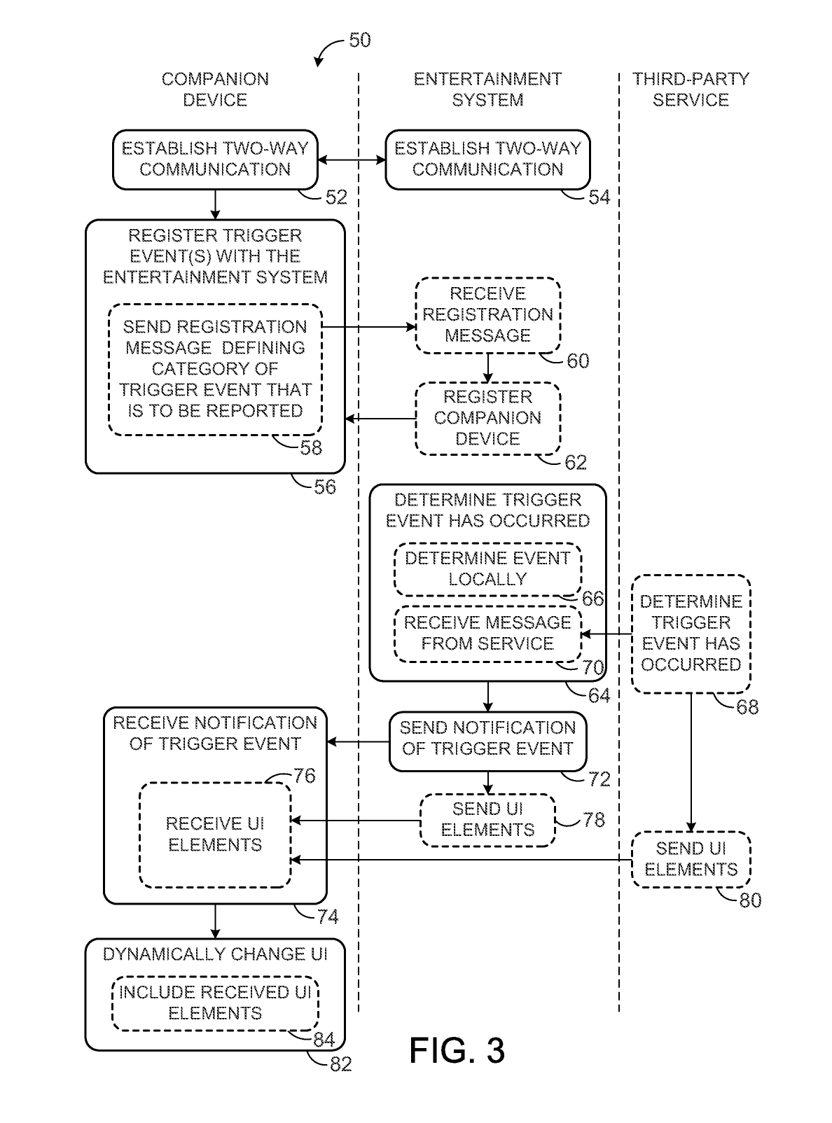

A companion device such as example companion device 32 configured to remotely control an entertainment system such as entertainment system 22 may be configured to dynamically change its user interface responsive to event notifications in any suitable manner. As an example, FIG. 3 illustrates a method 50 of dynamically changing a user interface of the companion device. As indicated at 52 and 54, two-way communication may be established with the entertainment system. In some embodiments, this two-way communication may be established between the companion device and the entertainment system via the Internet. In such a case, the companion device is, configured to connect to the Internet via a wireless network and/or other wireless protocol such as by using a mobile data plan (e.g., 3G Cellular, etc.). However, in some embodiments, two-way communication may be established directly between the companion device and the entertainment system via Bluetooth, infrared, radio-frequency, etc.

Upon establishing two-way communication, method 50 proceeds to 56 where the companion devices registers one or more trigger events with the entertainment system. A trigger event may include, for example, an event occurring at the entertainment system, such as a changing of content being provided by the entertainment system. As a nonlimiting example, content may change in response to a user's request, such as a channel change. As another nonlimiting example, content may automatically change at a program boundary transition when current programming ends and subsequent programming commences.

Such registration may be done in any suitable manner. For example, the companion device may send a registration message from the companion device to the entertainment system, as indicated at 58. Such a registration message may define a category of trigger event that is to be reported (e.g., all channel changes). In some embodiments, the registration message may further define an address to which the notification of the trigger event is to be reported upon occurrence of that category of trigger event.

In the case that the companion device sends a registration message, the entertainment system may then receive the message, as indicated at 60, and register the companion device as indicated at 62.

Next, upon registering the companion device, the entertainment system may determine that a trigger event has occurred, as indicated at 64. The entertainment system may determine a trigger event has occurred in any suitable manner. For example, in some embodiments, the entertainment system may be configured to locally detect such events, as indicated at 66. However, in some embodiments, a service may determine a trigger event has occurred, as indicated at 68, and may then send a message to the entertainment system to notify the entertainment system of the trigger event, as indicated at 70. In response to the trigger event, the entertainment system may then send a notification of the trigger event to the companion device, as indicated at 72.

Thus, method 50 proceeds to 74, wherein upon occurrence of a trigger event, the companion device receives a notification of the trigger event from the entertainment system. In some embodiments, this may include receiving user interface elements responsive to the notification, as indicated at 76. Such user interface elements may be sent by the entertainment system and/or service, as indicated at 78 and 80 respectively.

Next, method 50 proceeds to 82, wherein the companion device dynamically changes the user interface of the companion device responsive to the notification. In the case that the companion device received user interface elements from the entertainment system and/or service, the user interface may be dynamically changed to include those user interface elements, as indicated at 84. In some embodiments, the entertainment system may be configured to provide content, for example to a display device, and the user interface elements sent to the companion device may be associated with the content. As a nonlimiting example, dynamically changing the user interface of the companion device may include updating a theme of the user interface based on content being provided by the entertainment system. As another nonlimiting example, dynamically changing the user interface of the companion device may include visually presenting an advertisement.

It should be appreciated that the user interface of the companion device may dynamically change in any suitable manner. For example, the user interface may dynamically change to have a different aesthetic to match the content on the entertainment system, but may retain the same virtual buttons and controls, thus remaining functionally-equivalent to a previously-displayed user interface. This is illustrated by way of example at FIG. 2, wherein the user interface 40 dynamically changes to user interface 44 at time t₂, and although the aesthetic changes to match updated content 42, the same virtual buttons as displayed within user interface 40 persist.

As another example, the user interface may dynamically change to have different virtual buttons and/or controls to functionally augment the content on the entertainment system. For example, if the content on the entertainment center is a basketball game, then the user interface may include virtual buttons for changing the channel to other sporting events that are currently playing. Further, if the content on the entertainment system changes to a movie, then the user interface may dynamically change to present controls for selecting subtitles, viewing environments, surround-sound preferences, etc.

As yet another example, the user interface may dynamically change to include content that supplements the main content on the entertainment system. For example, if content on the entertainment system has changed to a basketball game, then the user interface of the companion device may dynamically change to display a player's statistics for the basketball game, an upcoming game schedule, etc.

As yet another example, the user interface may dynamically change to include advertisements targeted to content on the entertainment system. For example, in the above-described case where the content is a basketball game, the user interface of the companion device may dynamically change to display an advertisement for basketball shoes, tickets to a next game, etc. As another example, for the case where the content is a movie, the user interface of the companion device may dynamically change to display an advertisement for action figures of the movie, restaurant promotions related to the movie, etc.

It should be appreciated that in some embodiments the companion device may be configured to dynamically change its user interface responsive to events other than a notification. For example, an Internet Protocol (IP)-based companion device may be configured to query the entertainment system for the current content using a Transmission Control Protocol (TCP). As another example, the companion device may query a service to determine the content being provided by the entertainment system.

It should be further appreciated that the user interface may dynamically change responsive to any suitable trigger events, such as program boundaries, arbitrary time boundaries, channel boundaries, randomly, and/or any other suitable criteria related to the content being presented by the entertainment system.

It should be further appreciated that the entertainment system may be further configured to support communication of a content identifier and/or metadata. The metadata may be exposed, for example, through an external server and/or directly to the companion device. The companion device may then be configured to detect the identity of the content being presented, and select user interface elements (e.g., advertising) based on that content, and dynamically change its user interface to include those user interface elements.

In some embodiments, the above described methods and processes may be tied to a computing system including one or more computers. In particular, the methods and processes described herein may be implemented as a computer application, computer service, computer API, computer library, and/or other computer program product.

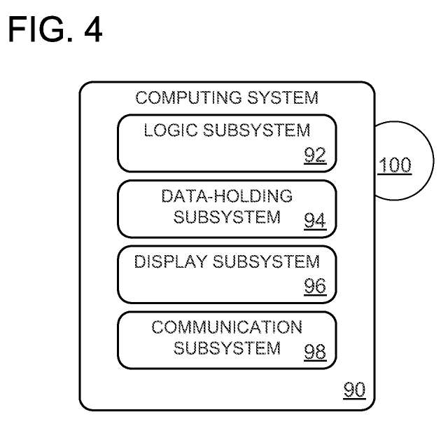

FIG. 4 schematically shows a nonlimiting computing system 90 that may perform one or more of the above described methods and processes. For example, computing system 90 may be an entertainment system such as entertainment system 22 or a companion device such as companion device 32. Computing system 90 is shown in simplified form. It is to be understood that virtually any computer architecture may be used without departing from the scope of this disclosure. In different embodiments, computing system 90 may take the form of a mainframe computer, server computer, desktop computer, laptop computer, tablet computer, home entertainment computer, network computing device, mobile computing device, mobile communication device, gaming device, etc.

Computing system 90 includes a logic subsystem 92 and a data-holding subsystem 94. Computing system 90 may optionally include a display subsystem 96, communication subsystem 98, and/or other components not shown in FIG. 4. Computing system 90 may also optionally include user input devices such as keyboards, mice, game controllers, cameras, microphones, and/or touch screens, for example.

Logic subsystem 92 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions, such as instructions for dynamically changing a user interface of the companion device. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 94 may include one or more physical, non-transitory, devices configured to hold data and/or instructions executable by the logic subsystem to implement the herein described methods and processes. When such methods and processes are implemented, the state of data-holding subsystem 94 may be transformed (e.g., to hold different data).

Data-holding subsystem 94 may include removable media and/or built-in devices. Data-holding subsystem 94 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 94 may include devices with one or more of the following characteristics: volatile, nonvolatile, dynamic, static, read/write, read-only, random access, sequential access, location addressable, file addressable, and content addressable. In some embodiments, logic subsystem 92 and data-holding subsystem 94 may be integrated into one or more common devices, such as an application specific integrated circuit or a system on a chip.

FIG. 4 also shows an aspect of the data-holding subsystem in the form of removable computer-readable storage media 100, which may be used to store and/or transfer data and/or instructions executable to implement the herein described methods and processes. Removable computer-readable storage media 100 may take the form of CDs, DVDs, HD-DVDs, Blu-Ray Discs, EEPROMs, and/or floppy disks, among others.

The terms “module,” “program,” and “engine” may be used to describe an aspect of computing system 90 that is implemented to perform one or more particular functions. In some cases, such a module, program, or engine may be instantiated via logic subsystem 92 executing instructions held by data-holding subsystem 94. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 96 may be used to present a visual representation of data held by data-holding subsystem 94. As the herein described methods and processes change the data held by the data-holding subsystem, and thus transform the state of the data-holding subsystem, the state of display subsystem 96 may likewise be transformed to visually represent changes in the underlying data. Display subsystem 96 may include one or more display devices utilizing virtually any type of technology. Such display devices may be combined with logic subsystem 92 and/or data-holding subsystem 94 in a shared enclosure, or such display devices may be peripheral display devices.

When included, communication subsystem 98 may be configured to communicatively couple computing system 90 with one or more other computing devices. Communication subsystem 98 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 90 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a companion device configured to remotely control an entertainment system, a method of dynamically changing a user interface of the companion device, the method comprising:
establishing two-way communication with the entertainment system;
registering one or more trigger events with the entertainment system;
upon occurrence of a trigger event, receiving a notification of the trigger event from the entertainment system; and
dynamically changing the user interface of the companion device responsive to the notification.

2. The method of claim 1, wherein registering one or more trigger events includes sending a registration message from the companion device to the entertainment system, the registration message defining a category of trigger event that is to be reported.

3. The method of claim 2, wherein the registration message further defines an address to which the notification of the trigger event is to be reported upon occurrence of that category of trigger event.

4. The method of claim 1, wherein the trigger event comprises an event occurring at the entertainment system.

5. The method of claim 1, wherein the trigger event comprises a changing of content being provided by the entertainment system.

6. The method of claim 1, wherein the user interface is dynamically changed to include user interface elements sent from the entertainment system.

7. The method of claim 1, wherein the user interface is dynamically changed to include user interface elements sent from a network-accessible service.

8. The method of claim 1, wherein dynamically changing the user interface of the companion device comprises updating a theme of the user interface based on content being provided by the entertainment system.

9. The method of claim 1, wherein dynamically changing the user interface of the companion device comprises visually presenting an advertisement.

10. The method of claim 1, wherein two-way communication is established between the companion device and the entertainment system via the Internet.

11. The method of claim 1, wherein two-way communication is established directly between the companion device and the entertainment system.

12. The method of claim 1, wherein the companion device is a mobile communication device.

13. On an entertainment system, a data-holding subsystem holding instructions executable by a logic subsystem to:
establish two-way communication with a companion device;
receive a registration message from the companion device for one or more trigger events at the entertainment system;
register the companion device;
upon registering the companion device, determine a trigger event has occurred;
in response to the trigger event, send a notification of the trigger event to the companion device; and
send user interface elements to the companion device for changing a user interface of the companion device.

14. The data-holding subsystem of claim 13, wherein the instructions are further executable to provide content to a display device, and wherein the user interface elements are associated with the content.

15. The data-holding subsystem of claim 13, wherein the trigger event comprises a changing of content being provided by the entertainment system.

16. The data-holding subsystem of claim 13, wherein the registration message defines a category of trigger event that is to be reported.

17. The data-holding subsystem of claim 16, wherein the registration message further defines an address to which the notification of the trigger event is to be reported upon occurrence of that category of trigger event.

18. A companion device, comprising:
a display for displaying a user interface;
a communication subsystem configured to communicatively couple the companion device with one or more other computing devices;
a logic subsystem for executing instructions;
a data-holding subsystem holding instructions executable by the logic subsystem to:
establish, via the communication subsystem, two-way wireless communication with an entertainment system configured to provide content to a television;
register one or more trigger events with the entertainment system;
upon occurrence of a trigger event comprising a channel change or a program boundary transition at the entertainment system, receive notification of the trigger event from the entertainment system;
receive, from one of the entertainment system and a network-accessible service, user interface elements for changing the user interface displayed on the display; and
dynamically change the user interface displayed on the display to include the user interface elements.

19. The companion device of claim 18, wherein the instructions are executable to register one or more trigger events with the entertainment system by sending a registration message from the companion device to the entertainment system, the registration message defining a category of trigger event that is to be reported.

20. The companion device of claim 18, wherein the instructions are further executable to query the entertainment system to determine the content being provided to the television.
